(19) United States
(12) Patent Application Publication
(10) Pub. No.: US 2025/0319783 A1
(43) Pub. Date: Oct. 16, 2025

(54) PORTABLE ELECTRIC VEHICLE CHARGER

(71) Applicant: Vital Pak LLC, Albany, NY (US)

(72) Inventors: Frederick Weinraub, Albany, NY (US); Fernando Ocaña, Flushing, NY (US)

(21) Appl. No.: 19/249,722

(22) Filed: Jun. 25, 2025

Related U.S. Application Data
(63) Continuation of application No. 18/811,611, filed on Aug. 21, 2024.
(60) Provisional application No. 63/556,401, filed on Feb. 22, 2024.
(60) Provisional application No. 63/662,805, filed on Jun. 21, 2024.

(51) Int. Cl. B60L 53/30; B60L 53/18; B60L 53/53; B60L 53/57; B62B 5/06

(52) U.S. Cl. CPC B60L 53/30; B60L 53/18; B60L 53/53; B60L 53/57; B62B 5/067

(57) ABSTRACT

Systems, methods, and apparatus for a portable electric vehicle charger as shown and described. A portable electric vehicle (EV) battery charger can include an integrated rechargeable power bank and retractable cable having an interchangeable headpiece. A charging device for an electric vehicle includes a housing including at least one battery for supplying electric power to an electric vehicle. The charging device includes a first connection terminal connected to the at least one battery configured to supply power from an external power source to the at least one battery, and a second connection terminal connected to the battery to supply power stored in the at least one battery to the electric vehicle via the retractable charging cord.

### CROSS-REFERENCE TO RELATED APPLICATIONS

Priority is claimed from U.S. application Ser. No. 18/811,611 filed Aug. 21, 2024 and entitled “Portable Electric Vehicle Charger”, which in turn claims priority from i) U.S. Provisional Application No. 63/662,805, filed on Jun. 21, 2024 and entitled “Portable Electric Vehicle Charger”, and ii) U.S. Provisional Application No. 63/556,401 filed Feb. 22, 2024 and entitled “Portable Power Bank with Integrated EV Charging Connector”, the entire contents of the latter two of which are hereby incorporated by reference.

### TECHNICAL FIELD

The present disclosure is directed towards a portable electric vehicle charger.

### BACKGROUND

Electric vehicles (“EVs”) include a battery that stores power and supplies the stored power to an electric motor for driving a vehicle. The driving range or maximum achievable distance for the EV is governed by the power stored in the EV battery.

Owners of electric vehicles often experience “range anxiety” or anxiety associated with inadequate charging infrastructures and the EV having a limited supply of power and being unable to recharge their EV when needed. Unlike in a traditional internal combustion engine (“ICE”) vehicle, which can be refueled using gas stations that are readily available, EV charging infrastructure is not as widespread. EV charging infrastructure can be inadequate and disparate in regions.

The inadequate charging infrastructure for EVs is conventionally addressed by improving the battery in the EV and/or making improvements to stationary chargers (e.g., Supercharger systems). However, these are limited in their effectiveness and portability.

### SUMMARY

Disclosed are apparatus, systems, and methods directed towards a portable electric vehicle charger. In some aspects, the portable electric vehicle charger can be stowed in an electric vehicle and be used to provide that electric vehicle with additional driving range when needed.

In some aspects, a portable electric vehicle (EV) charger can feature an integrated rechargeable power bank and retractable cable. The power bank can be integrated into the housing of the charger and can be charged using conventional outlets. The cable can be permanently attached to the power bank and can retract into the charger for easy storage and portability. Additionally, the other end of the cable can include an interchangeable headpiece, allowing users to switch between different types of connectors to accommodate various electric vehicles and charging standards.

In some aspects, a charging device for an electric vehicle includes: a housing including: at least one battery for supplying electric power to an electric vehicle, and a retractable charging cord coupled to the at least one battery; a first connection terminal connected to the at least one battery configured to supply power from an external power source to the at least one battery; and a second connection terminal connected to the at least one battery to supply power stored in the at least one battery to the electric vehicle via the retractable charging cord.

One or more of the following features can be included in any feasible combination. For example, in some aspects, the retractable charging cord includes a first end coupled to the at least one battery, and the first end is integrated with the at least one battery. In some aspects, the charging device, further includes: a retractable handle integrated into a portion of the housing; and one or more wheels integrated into a portion of the housing configured to translate the charging device. In some aspects, the housing further comprises a recessed compartment configured to hold the retractable charging cord. In some aspects, the housing of the charging device includes a panel having one or more LED lights indicating a charge status of the at least one battery and/or the electric vehicle. In some aspects, the housing includes one or more vents. In some aspects, a distal end of the retractable charging cord includes an interchangeable head piece. In some aspects, the panel includes one or more charging outlets. In some aspects, the retractable charging cord includes a length between about 10 feet to 50 feet. In some aspects, the recessed compartment further includes one or more locks for engaging with the retractable charging cord. In some aspects, the housing includes a length between about 12 to 18 inches, a width between about 12 to 18 inches, and a depth between about 4 to 10 inches. A charging device can include a weight between about 20 to 100 pounds. A charging device, can further include a second recess configured to include the first connection terminal. The housing includes a switch configured to actuate the flow of electricity to and from the at least one battery. In some aspects, the techniques described herein relate to a charging device, wherein the recessed compartment further includes a track configured to hold the retractable charging cord. In some aspects, the track spans two adjacent faces of a surface of the housing. In some aspects, the recessed compartment further includes a raised reel element configured to hold the retractable charging cord, wherein the track is positioned about a perimeter of the raised reel element. In some aspects, the housing further includes at least one support member. In some aspects, an interior of the housing includes a platform configured to support the at least one battery. In some aspects, the charging device includes a housing including aluminum, steel, or plastic and the at least one battery includes lithium, nickel, cobalt, manganese and/or graphite. In some aspects, the charging device has at least one battery that holds at least a 2 kWh charge. The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 illustrates a first view of an example portable electric vehicle charger in accordance with some aspects of the described.

FIG. 2 illustrates a second view of an example portable electric vehicle charger in accordance with some aspects of the described.

FIG. 3 illustrates a third view of an example portable electric vehicle charger in accordance with some aspects of the described.

FIG. 4 illustrates a fourth view of an example portable electric vehicle charger in accordance with some aspects of the described.

FIG. 5A illustrates a first view of an example second embodiment of a portable electric vehicle charger in accordance with some aspects of the described.

FIG. 5B illustrates a second view of the example second embodiment of a portable electric vehicle charger in accordance with some aspects of the described.

FIG. 5C illustrates a third view of the example second embodiment of a portable electric vehicle charger in accordance with some aspects of the described.

FIG. 5D illustrates a fourth view of the example second embodiment of a portable electric vehicle charger in accordance with some aspects of the described.

FIG. 6A illustrates a first view of an example third embodiment of a portable electric vehicle charger in accordance with some aspects of the described.

FIG. 6B illustrates a second view of the example third embodiment of a portable electric vehicle charger in accordance with some aspects of the described.

FIG. 6C illustrates a third view of the example third embodiment of a portable electric vehicle charger in accordance with some aspects of the described.

FIG. 6D illustrates a fourth view of the example third embodiment of a portable electric vehicle charger in accordance with some aspects of the described.

FIG. 6E illustrates a fifth view of the example third embodiment of a portable electric vehicle charger in accordance with some aspects of the described.

FIG. 6F illustrates a sixth view of the example third embodiment of a portable electric vehicle charger in accordance with some aspects of the described.

FIG. 6G illustrates a seventh view of the example third embodiment of a portable electric vehicle charger in accordance with some aspects of the described.

FIG. 6H illustrates a eighth view of the example third embodiment of a portable electric vehicle charger in accordance with some aspects of the described.

FIG. 7A illustrates a first view of another example embodiment of a portable electric vehicle charger in accordance with some aspects of the described.

FIG. 7B illustrates a second view of the example embodiment of a portable electric vehicle charger in accordance with some aspects of the described.

FIG. 7C illustrates a third view of the example embodiment of a portable electric vehicle charger in accordance with some aspects of the described.

FIG. 7D illustrates a fourth view of the example embodiment of a portable electric vehicle charger in accordance with some aspects of the described.

FIG. 7E illustrates a fifth view of the example embodiment of a portable electric vehicle charger in accordance with some aspects of the described.

FIG. 7F illustrates a sixth view of the example embodiment of a portable electric vehicle charger in accordance with some aspects of the described.

FIG. 7G illustrates a seventh view of the example embodiment of a portable electric vehicle charger in accordance with some aspects of the described.

FIG. 7H illustrates an eighth view of the example embodiment of a portable electric vehicle charger in accordance with some aspects of the described.

FIG. 7I illustrates a ninth view of the example embodiment of a portable electric vehicle charger in accordance with some aspects of the described.

FIG. 7J illustrates a tenth view of the example embodiment of a portable electric vehicle charger in accordance with some aspects of the described.

FIG. 7K illustrates an eleventh view of the example embodiment of a portable electric vehicle charger in accordance with some aspects of the described.

Like reference symbols in the various drawings indicate like elements.

### DETAILED DESCRIPTION

Disclosed are apparatus, systems, and methods directed towards a portable electric vehicle charger.

A portable electric vehicle (EV) charger can include an integrated rechargeable power bank and retractable cable. The power bank can be integrated into the housing of the battery charger and can be charged using conventional outlets. The cable can be permanently attached to the power bank and can retract into the battery charger for easy storage and portability. Additionally, the other end of the cable can include an interchangeable headpiece, allowing users to switch between different types of connectors to accommodate various electric vehicles and charging standards.

For example, in some aspects, the portable electric vehicle charger can include a power bank including at least one battery that is capable of being charged via an electrical connection to a wall-unit or another car. The power bank can be enclosed within a casing or housing that forms a substantially rectangular shape. The battery can be composed of one or more metals such as lithium, nickel, cobalt, manganese, and/or graphite, or any combination thereof. The battery can be encased within aluminum, steel, or any other suitable material. The casing of the portable electric vehicle charger can be composed of plastic or other suitable materials. In some aspects, the battery can hold a 2 kWh charge.

In some aspects, the battery can be composed of lithium-ion (LiFePO4) configured to have a 2048 Wh capacity. The battery can be capable of connecting to a power source, such as a domestic outlet. The battery can be configured to charge within a timeframe of fifteen minutes, half an hour, one hour, two hours, or the like. In some aspects, the battery can be enclosed in a casing composed of galvanized steel or the like.

In some aspects, the portable electric vehicle charger can include a charging input port component configured to receive a charging cord. In some aspects, the charging cord can also be integrated into the portable electric vehicle charger. For example, the charging cord can be integral with the battery such that the charging cord's connection to the battery is not easily disconnected during normal use (e.g., the charging cord is not configured to be conveniently disconnected and reconnected from the battery). This can be achieved, for example, by enclosing the connection between the charging cord and the battery within the housing of the battery charger, by including one or more fasteners (e.g., screws, bolts, adhesive, and the like) that secure the charging cord to the battery, and the like. In some aspects, the charging cord can include a first end having a plug compatible with a wall-socket. A second end of the charging cord can reversibly engage with the charging input port.

In some aspects, the portable electric vehicle charger is portable and capable of being transported from one location to another. For example, the portable electric vehicle charger can include one or more wheels configured to contact the ground, such that the portable electric vehicle charger can be easily wheeled on a surface. In some aspects, the portable electric vehicle charger can include one or more handles configured to allow a user to lift and transport the portable electric vehicle charger. In some aspects, one or more handles can be attached to or integrated into a surface of the casing or housing. In some aspects, the portable electric vehicle charger can have a width between about 12 to 18 inches. In some aspects, the portable electric vehicle charger can have a length between about 12 to 18 inches. In some aspects, the portable electric vehicle charger can have a depth between about 4 to 10 inches. The weight of the portable electric vehicle charger can be between about 20-100 pounds. In some implementations, the weight of the portable electric vehicle charger can be between 40-60 pounds.

The portable electric vehicle charger can provide power to an electric vehicle. The portable electric vehicle charger can include a cable that is retractable and affixed to or integrated to a battery contained within a housing of the portable electric vehicle charger. In some implementations, the cable can be retractable. For example, the cable can be extended away from the portable electric vehicle charger casing and used to charge an electric vehicle. In some aspects, the cable can be locked in an extended position while it is charging a vehicle. After the cable is done charging the vehicle, it can be unlocked, and then retracted into the casing of the portable electric vehicle charger. For example, the cable can be engaged with a spool, wheel, or track that allows for expansion and retraction of the cable. The cable can include a reversible locking mechanism to keep the cable at a fixed length for a particular amount of time. The cable can have a total length between 10 ft-50 ft. In some implementations, the total cable length is 20 ft. As another example, a reel can be embedded or built into one or more sides of the housing. The reel can include one or more locks. In some aspects, the cable can be engaged with a reel such that the cable can be expanded to a desired length and then the reel may lock to maintain the length of the cable. A pull by a user on the cable can then release the lock allowing for the cable length to be modified. Advantageously, such a feature can eliminate the need for cord winding and reduce tangles between the cord.

In some implementations, an end of the cable can be configured to interface with one or more plugs capable of engaging with an electric vehicle. In some aspects, the cable may terminate in two or more plugs, each having a different shape.

The cable can have a first end engaged with the battery and a second end that includes an interchangeable head piece that accommodates different charging ports. Examples of interchangeable head pieces include, but are not limited to, the J1772 plug and the like. In some aspects, the head pieces or plugs can be interchanged with the cable, accordingly changing the cable is not required for compatibility with various electric vehicles. For example, a headpiece can be reversibly attached to the charging cable.

In some aspects, the systems, methods, and apparatus described herein can be used for roadside assistance, emergency services, fleets for governmental organizations (e.g., municipalities, national parks), hospitality services (e.g., lodging, ski resorts, etc.), universities, and the like.

For example, the configuration of components in an electric vehicle prevents them from being able to be towed by roadside assistance. For example, when an electric vehicle is inclined as is done by conventional towing methods, the wheels of the EV will spin, generating electricity which can be sent to the battery of the EV and cause damage. Accordingly, the disclosed portable electric vehicle charger can be used by roadside assistance fleets to provide charging to electric vehicles that cannot be towed by conventional methods. For example, it is envisioned that towing companies could use the disclosed system by accessing the retractable attached cable from the portable electric vehicle charger and then attaching it to the electric vehicle in need.

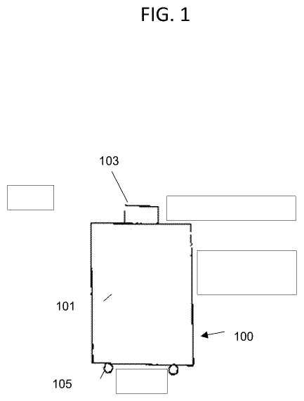

FIGS. 1-7K provide various views of an exemplary portable electric vehicle charger in accordance with some aspects of the described.

For example, FIG. 1 illustrates a first view of a portable electric vehicle charger 100 with a housing 101 in which there is a power bank or battery. The portable electric vehicle charger 100 includes one or more wheels 105 configured to allow the portable electric vehicle charger 100 to be translated on a surface. The housing 101 also includes a handle 103 that is extendable.

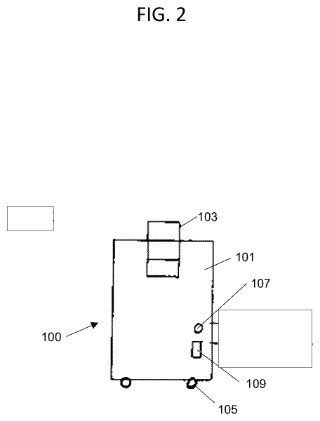

FIG. 2 illustrates a second view of a portable electric vehicle charger 100 with a housing 101 in which there is a power bank or battery. The portable electric vehicle charger 100 includes one or more wheels 105 configured to allow the portable electric vehicle charger 100 to be translated on a surface. The housing 101 also includes a handle 103 that is extendable. As shown, the housing 101 can include a button 107 or other actuator that is configured to interface with the power bank and allow the power bank to charge an electric vehicle connected to the portable electric vehicle charger 100. The housing 101 can also include a charging input port 109 configured to receive a cable configured to charge the power bank or battery located within the housing 101.

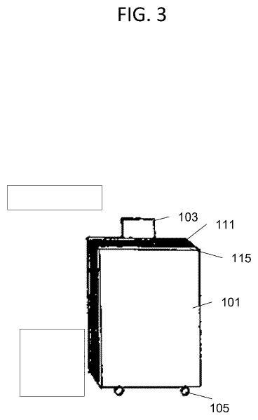

FIG. 3 illustrates a third view, a perspective view, of a portable electric vehicle charger 100 with a housing 101 in which there is a power bank or battery. As shown in FIG. 3, a cable 111 can be integrated with the housing 101 and secured within a track 115 that forms a perimeter about the housing 101. As shown, in some aspects, the track 115 can be formed within two sides of the housing 101. The cable can be secured to the track using a fastener.

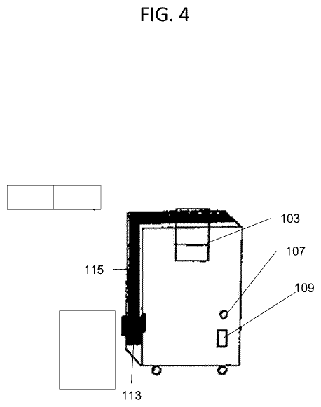

FIG. 4 illustrates a fourth view, a perspective view, of a portable electric vehicle charger 100 with a housing 101 in which there is a power bank or battery. As shown in FIG. 4, a first end of the cable 111 can be connected to an electric vehicle charging connector port 113. A second end of the cable 111 can be connected to the power bank or battery held within the housing 101.

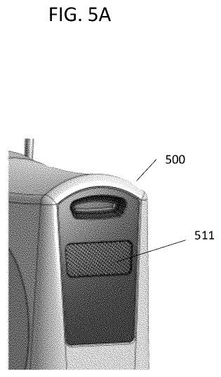

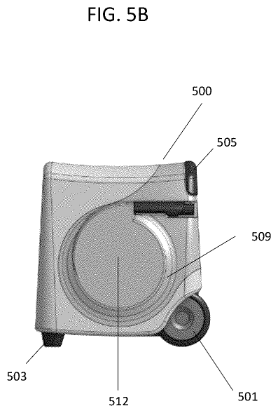

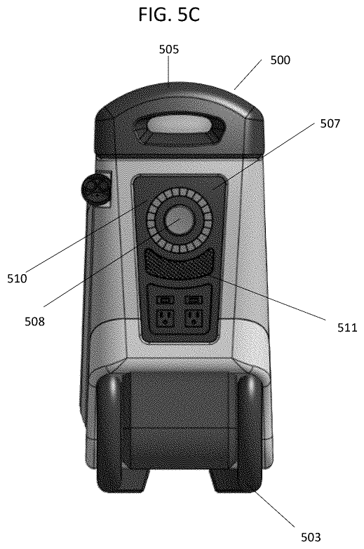

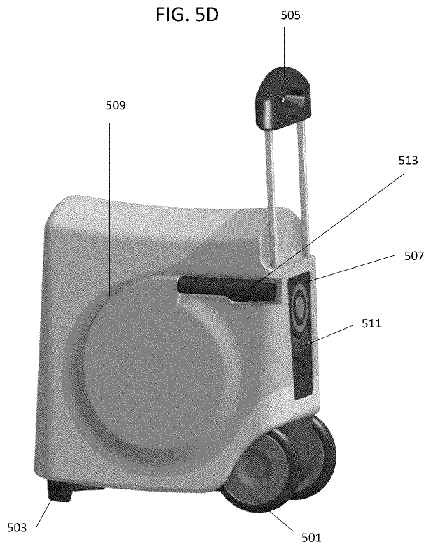

FIGS. 5A-5D illustrates various views of a second embodiment of a portable electric vehicle charger in accordance with some aspects of the described. As shown, a portable electric vehicle charger 500 can include one or more wheels 501 positioned along a base and configured to move the portable electric vehicle charger 500 across a surface. The base can also include a stand or foot stud 503 or the like configured to provide vertical support and stability to the portable electric vehicle charger 500.

A first side portion of the portable electric vehicle charger can include a retractable handle 505 configured to help move the portable electric vehicle charger. In some embodiments, the handle 505 can be locked into an expanded or retracted position. Accordingly, it is envisioned that a user can move the portable electric vehicle charger 500 by using a combination of the wheels and pull-out handle, or by lifting the charger 500 using the handle 505. A side of the portion of the portable electric vehicle charger can also include a control panel 507. In some implementations, the control panel 507 can be positioned on the same side or adjacent to the handle 505. The control panel can include a power button 508, display, outlets and the like. For example, in the illustrated embodiment, the control panel 507 includes two plug outlets and two USB outlets. In the illustrated embodiment, the control panel 507 can include an on or off button or power button 508 surrounded by a circular power level display 510. The circular power level display 510 can be configured to indicate the amount of power or charge in the portable electric vehicle charge. The circular power level display 510 can use a combination of graphics, colors, symbols, or the like.

As shown in FIGS. 5B and 5D, in some aspects the retractable cable 509 can be recessed into the side of the portable electric vehicle charger. The end of the retractable cable 509 can be configured to attach to an interchangeable head piece 513 that accommodates different charging ports. The retractable cable 509 can be fitted interior to a bossed surface 512. As shown in FIG. 5A, in some embodiments, the housing can include a vent panel 511.

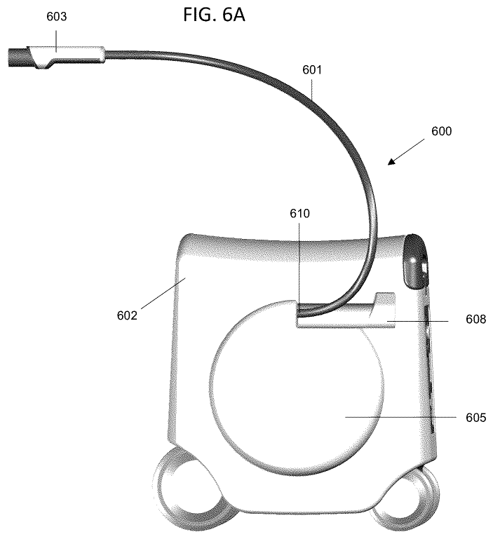

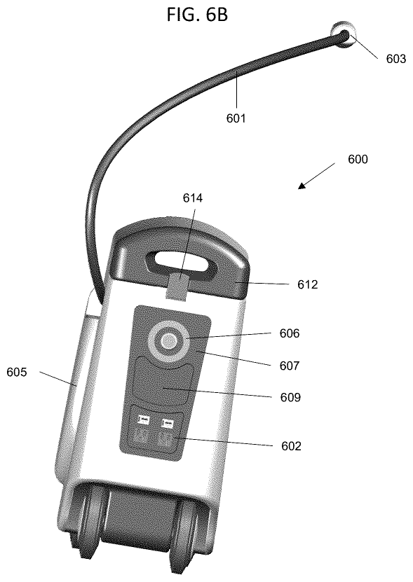

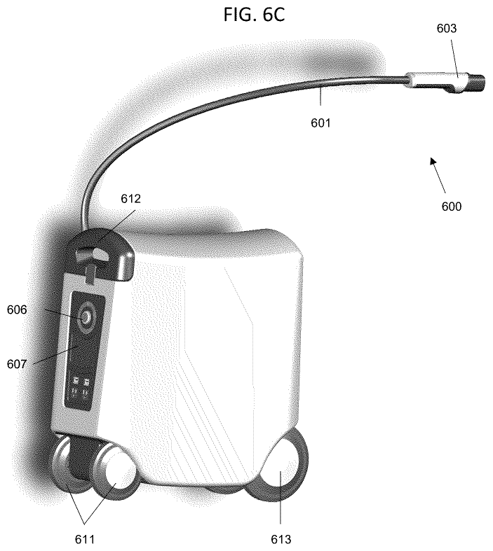

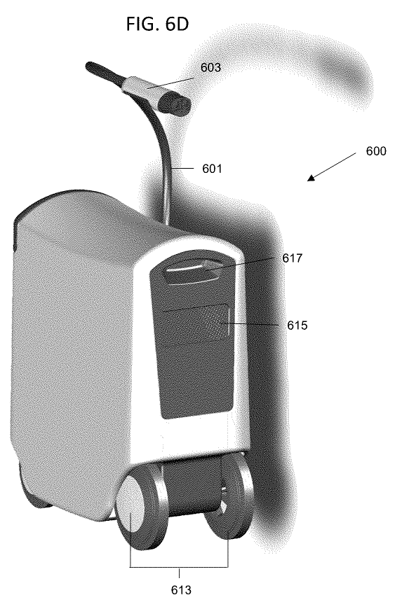

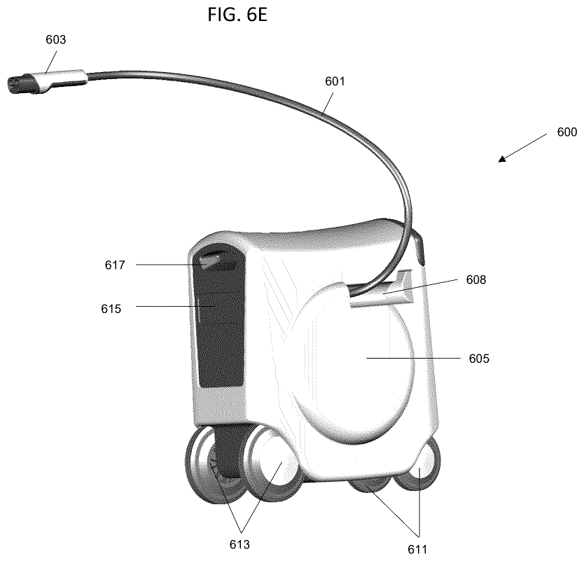

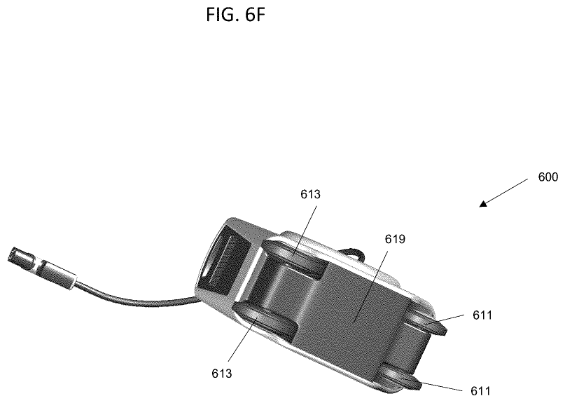

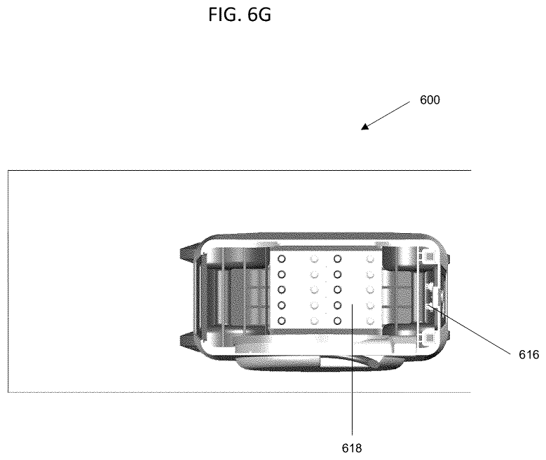

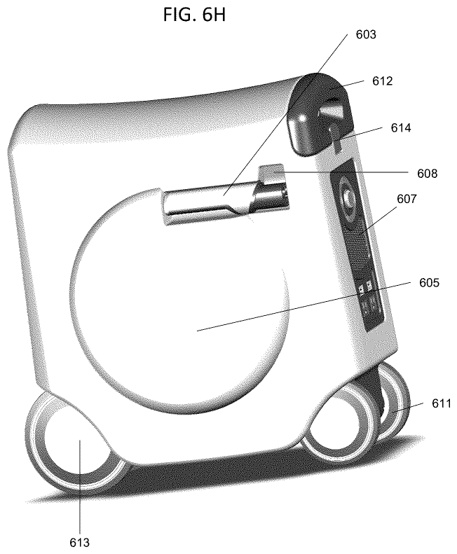

FIGS. 6A-6H provide various views of a portable electric vehicle charger as described herein. FIG. 6A provides a first side view of a portable electric vehicle charger or charging device 600. The portable electric vehicle charger or charging device 600 includes a housing 602 that houses at least one battery for supplying electric power to an electric vehicle. The housing 602 can be composed of aluminum, steel, or plastic. A first connection terminal of the battery can be configured to supply power from an external power source to the battery. A second connection terminal connected to the battery can be configured to supply the power stored in the battery to an electric vehicle via a retractable charging cord. A distal end of the retractable charging cord can include an interchangeable head piece.

The housing 602 can include a recessed component that is configured to hold a retractable charging cord 601. Illustrated is a retractable charging cord 601 with an interchangeable plug 603. As shown, interchangeable plug 603 can include a J1772 plug configured to provide electric power to an electric vehicle. The portable electric vehicle charger or charging device 600 can include a recessed portion 610 that includes a track for holding the retractable cord. The retractable cord 601 can be wound around the track. In some embodiments, the recessed compartment further includes a raised reel element configured to hold the retractable charging cord, where the track is positioned about a perimeter of the raised reel element. As shown, in some embodiments, the housing can include a portion configured to cover the track that is configured to hold the retractable cord 601. The housing can have a protruding surface 605 that covers the track. The track can be located on a face of the portable electric vehicle charger. In the illustrated embodiment, a recessed portion 608 that is configured to be exposed to the environment and shaped to hold the interchangeable plug 603. The retractable charging cord 601 can have a length between about 10 feet to 50 feet. In some aspects, a lock can be located in the housing that is operated by a spring-loaded reel in the track.

FIG. 6B provides a front view of the portable electric vehicle charger or charging device 600. As shown in FIG. 6B, a control panel 607 can include one or more lights or icons configured to indicate the battery capacity and power levels of the one or more batteries in the portable electric vehicle charger or charging device 600. For example, the control panel 607 can have one or more LED lights 606 that indicate a charge status of the at least one battery and/or the electric vehicle. The LED lights 606 can be arranged as a circle and a percentage of the completed circle can correspond to the percentage of battery power.

A vent 609 can be positioned alongside one or more surfaces of the housing and be configured to allow airflow between the inside and outside of the housing. Further, the control panel 607 can include one or more buttons for actuating the flow of power. For example, the control panel 607 can include a switch to turn on or off delivering power to the battery from an external source (e.g., wall unit, another car). The control panel 607 can include one or more switches to turn on or off delivering power to an electric vehicle from the electricity stored in the one or more batteries. In some aspects, the switch can be in an “on” position to enable a flow of electricity to and from the battery. The control panel 607 can include one or more ports configured to engage with a cable providing power to the one or more batteries of the portable electric vehicle charger or charging device 600. The control panel 607 can include various ports 602 such as charging ports, USB ports, or plug points configured to facilitate charging of alternative devices by the portable electric vehicle charger or charging device 600. In some aspects, the housing can include one or more fans or other cooling components.

Additionally, as shown in FIG. 6B in some embodiments, the portable electric vehicle charger or charging device 600 can include a handle 612 that is substantially u-shaped, t-shaped or the like. The handle 612 can be telescoping. The handle 612 can be ergonomic. In some embodiments, the handle 612 can have an adjustable height and a locking mechanism can mediate the handle between various lengths. In some embodiments, the handle 612 can be secured to the housing using a clip 614. In some embodiments, at least a portion of the retractable handle 612 can be integrated into a portion of the housing.

FIG. 6C provides a side perspective view of the portable electric vehicle charger or charging device 600. As shown in FIG. 6C, in some embodiments, the portable electric vehicle charger includes two sets of wheels. A first set of wheels 611 positioned proximate the control panel may have a smaller diameter than a second set of wheels 613 positioned opposite the control panel. Each of the first set of wheels and the second set of wheels can include two wheels connected by an axis, where the axis spans across the width of the housing. The wheels can be configured to help translate the portable electric vehicle charger or charging device 600 across a plurality of pavement surfaces including asphalt, dirt, gravel, concrete, and the like. In this manner, the disclosed system can be easily portable. In some embodiments, the base of the portable electric vehicle charger or charging device 600 can include one or more support elements positioned proximate to the wheels and configured to help support the charging device in an upright configuration.

FIG. 6D provides a side perspective view of the portable electric vehicle charger or charging device 600. As shown a surface of the housing opposite the control panel can include a second recessed handle 617 configured for easier lifting of the portable electric vehicle charger or charging device 600. Accordingly, the disclosed systems can be easily portable. For example, the housing can have a length between about 12 to 18 inches, a width between about 12 to 18 inches, and a depth between about 4 to 10 inches. Additionally, the portable electric vehicle charger or charging device 600 can have a weight between 20 to 100 pounds, such that it can be lifted and translated. FIG. 6D also illustrates a second vent 615 configured to allow airflow between the inner and outer parts of the housing. Accordingly, the second vent 615 can be configured to cool elements contained within the housing. FIG. 6E provides another side perspective view of the portable electric vehicle charger or charging device 600.

FIG. 6F provides a bottom perspective view of the portable electric vehicle charger or charging device 600. As shown the two sets of wheels can be positioned on opposing sides and be separated by a support member 619.

FIG. 6G provides a cross sectional top down view of the portable electric vehicle charger or charging device 600. As illustrated, the interior of the housing can include one or more compartments 616 store electrical components for the control panel including LED lights, a switchboard, and the like.

As shown in FIG. 6G, the interior of the housing can include a platform 618 configured to hold one or more batteries. In some embodiments, the interior of the housing can hold a single battery. In some embodiments, the interior of the housing holds a plurality of batteries in a stacked configuration. For example, each of the batteries can be arranged in stacked compartments along the height of the portable electric vehicle charging device. The batteries can be composed of one or more of lithium, nickel, cobalt, manganese, and/or graphite. Each battery can be configured to hold a charge of at least 2 kWh. It is envisioned that various materials and sizes an be used for the battery and/or housing components.

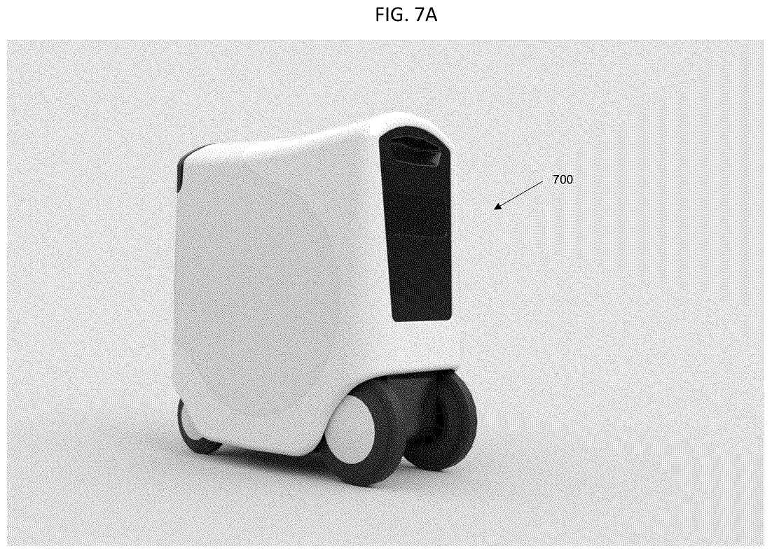

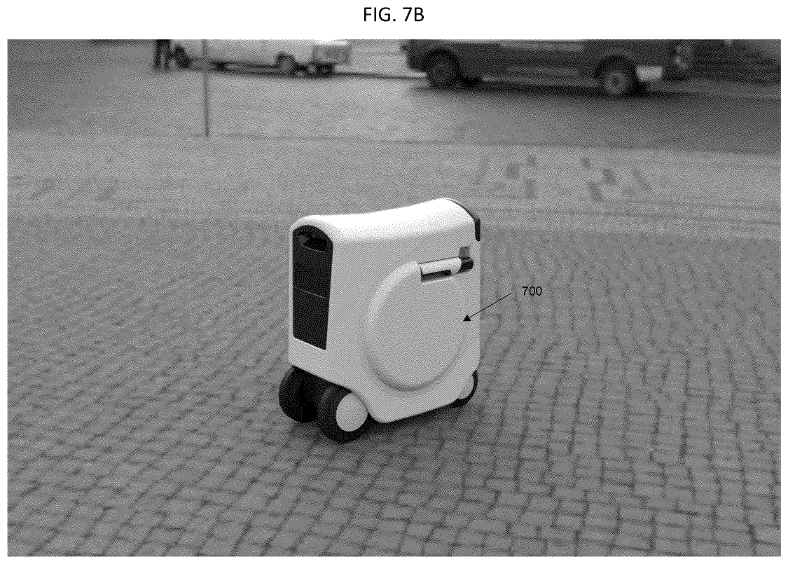

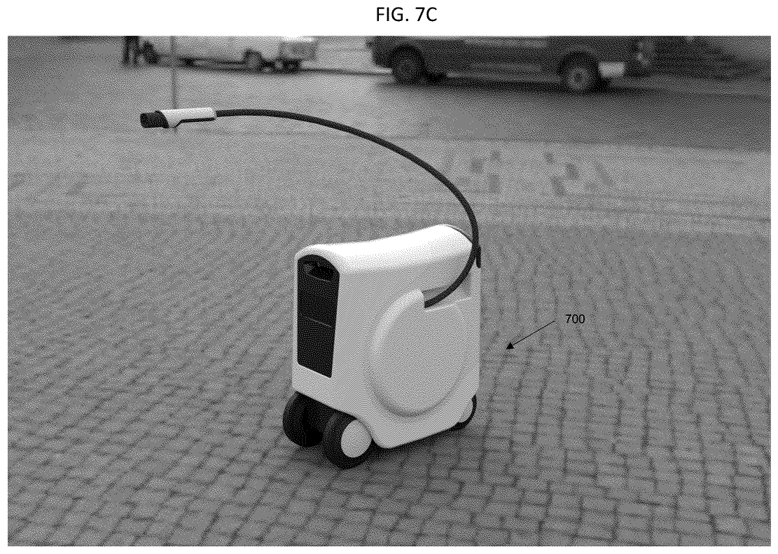

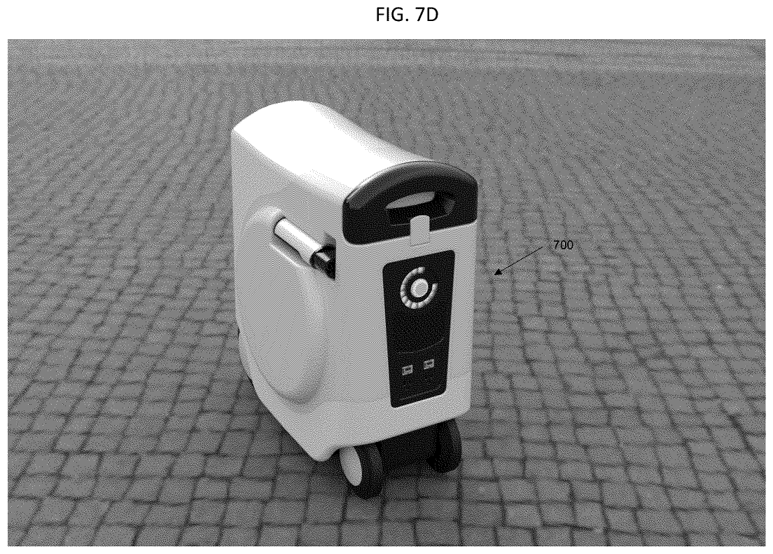

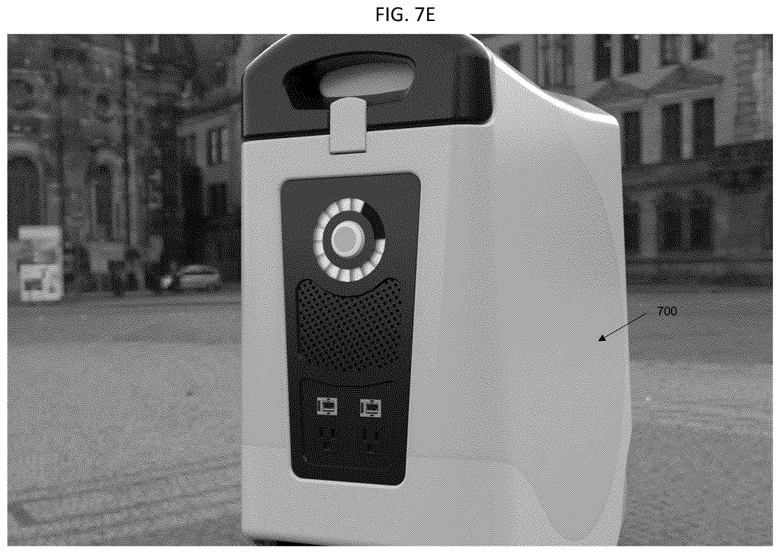

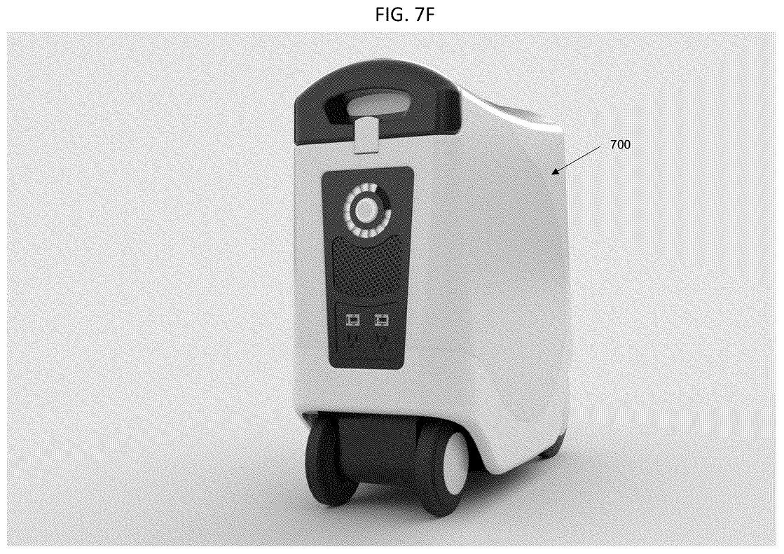

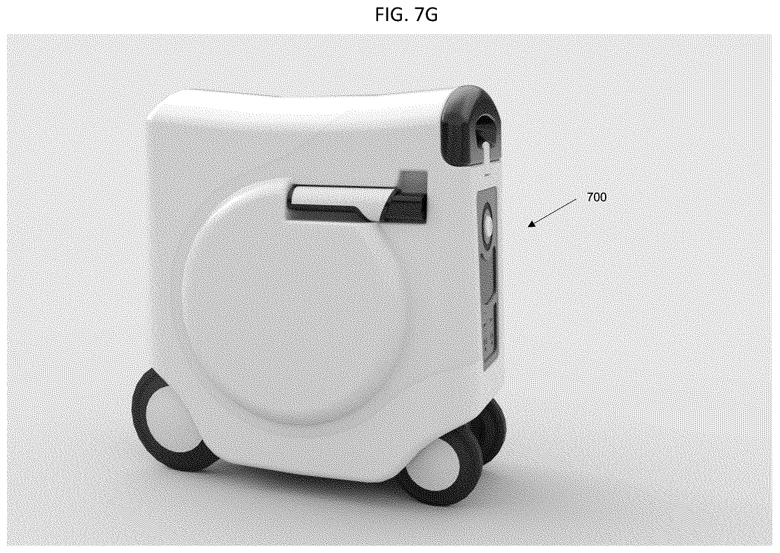

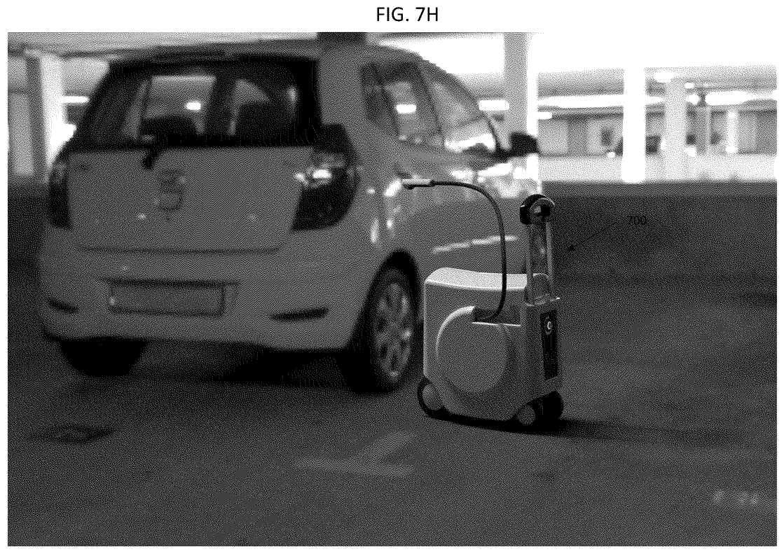

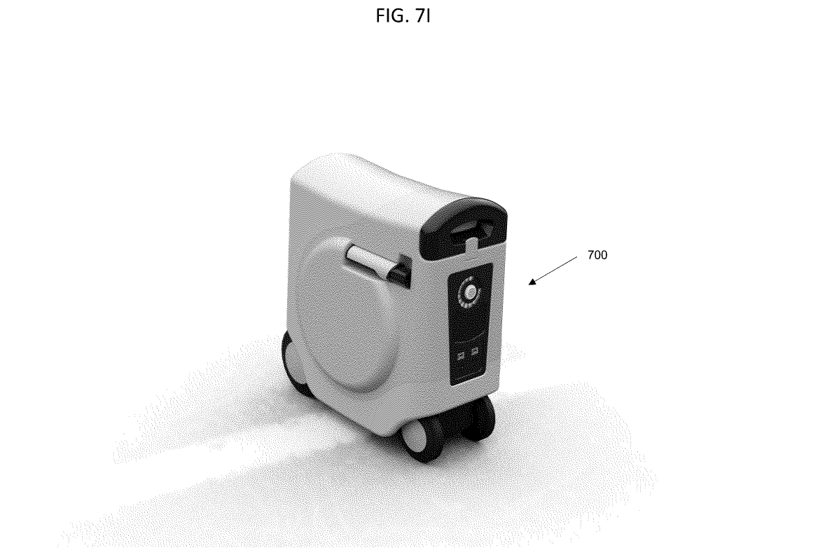

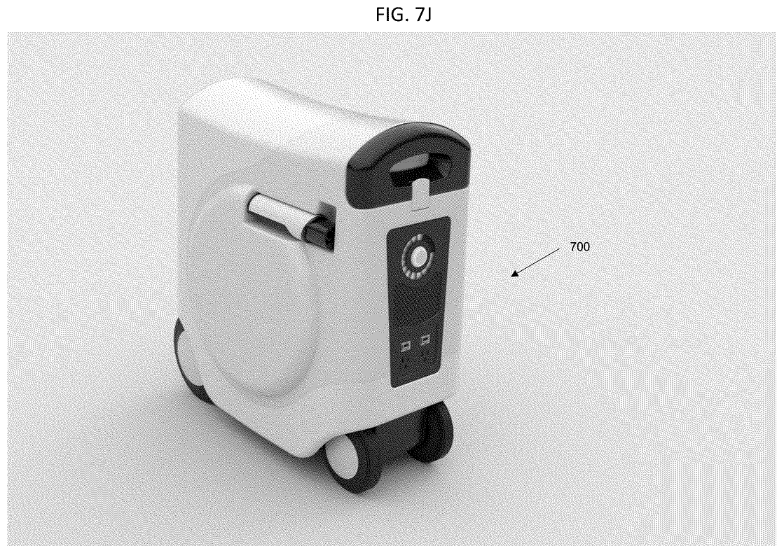

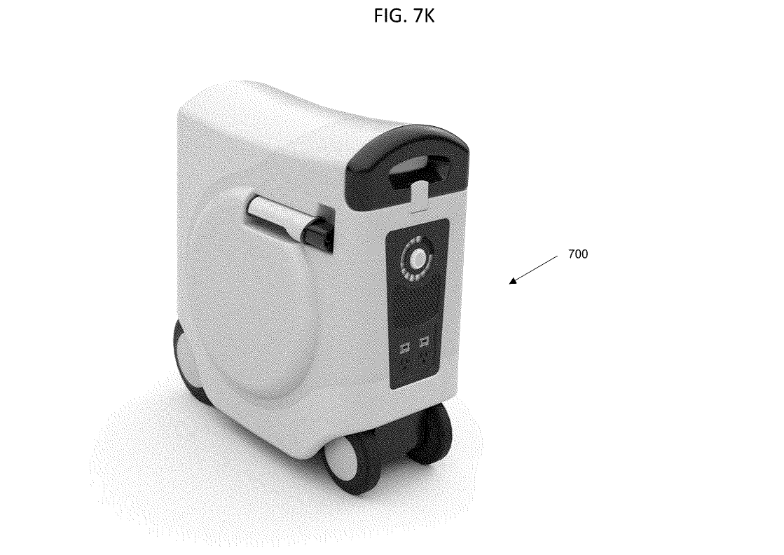

FIG. 6H provides a side perspective view, where the retractable charging cord is retracted and secured to the housing, such that the interchangeable head is secured to the recessed portion 608. As shown, in some embodiments, the top surface of the housing can include a curved surface. The curved surface can be aesthetically pleasing. In some embodiments, the top surface can be flat. In some embodiments, a charging cord can be plugged into the portable electic vehicle charging device and a second end can be connected to an appropriate outlet such as a wall outlet or the like. FIGS. 7A-7K illustrate a portable electric vehicle charger or charging device in various configurations. The portable electric vehicle charger or charging device 700 can be translated to be in proximity to an electric vehicle using handles and/or wheels. The retractable cord including a plug can be removed from the recess in the housing of the portable electric vehicle charging device. The plug can then be connected to an electric vehicle. A switch on the control panel of the portable electric vehicle charging device can be actuated to control the flow of power from the battery contained within the housing to the electric vehicle. Once the electric vehicle is charged, the plug can be removed from the electric vehicle. The retractable cord can be biased to return to its position in the recess in the housing.

Although a few variations have been described in detail above, other modifications or additions are possible. It is envisioned that the portable electric vehicle charger described herein can be composed of different battery chemistries, such as Lithium-Manganese-Cobalt, different charging capacities, weights, and sizes, and different methods of retractions.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A self-contained, portable electric vehicle charging device, comprising:
a housing;
at least one battery, adapted to supply electric power to an electric vehicle, disposed in said housing;
a charging cord electrically connected to said at least one battery;
a first connection terminal electrically connected to said at least one battery and configured to supply power from an external power source to said at least one battery; and
a second connection terminal electrically connected to said at least one battery and electrically connectable to the electric vehicle to supply power stored in said at least one battery to the electric vehicle via said charging cord.

2. A self-contained, portable electric vehicle charging device according to claim 1, wherein said charging cord is retractable.

3. A self-contained, portable electric vehicle charging device according to claim 1, further comprising:
a handle connected to said housing; and
one or more wheels attached to said housing enabling movement of said self-contained, portable electric vehicle charging device.

4. A self-contained, portable electric vehicle charging device according to claim 1, wherein the housing further comprises a panel having one or more LED lights indicating a charge status of the at least one battery and/or the electric vehicle.

5. A self-contained, portable electric vehicle charging device according to claim 1, wherein a distal end of said charging cord comprises an interchangeable head piece connectable to the electric vehicle.

6. A self-contained, portable electric vehicle charging device according to claim 4, wherein said panel comprises one or more charging outlets.

7. A self-contained, portable electric vehicle charging device according to claim 2, said housing further comprising a recessed compartment configured to hold the retractable charging cord; and
said recessed compartment further comprising one or more locks for engaging with said retractable charging cord.

8. A self-contained, portable electric vehicle charging device according to claim 1, wherein said housing comprises a length between about 12 to 18 inches, a width between about 12 to 18 inches, and a depth between about 4 to 10 inches.

9. A self-contained, portable electric vehicle charging device according to claim 1, wherein said self-contained, portable electric vehicle charging device comprises a weight between about 20 to 100 pounds.

10. A self-contained, portable electric vehicle charging device according to claim 7, further comprising a second recessed compartment configured to house said first connection terminal.

11. A self-contained, portable electric vehicle charging device according to claim 1, wherein said housing comprises at least one switch configured to actuate a flow of electricity to and from said at least one battery.

12. A self-contained, portable electric vehicle charging device according to claim 1, wherein said housing further comprises a recessed compartment configured to hold said charging cord, wherein the recessed compartment further comprises a track configured to hold said charging cord.

13. A self-contained, portable electric vehicle charging device according to claim 1, said housing further comprising a track configured to hold said charging cord.

14. A self-contained, portable electric vehicle charging device according to claim 12, wherein said first recessed compartment further includes a raised reel element configured to hold said charging cord, wherein said track is positioned about a perimeter of said raised reel element.

15. A self-contained, portable electric vehicle charging device according to claim 1, wherein said at least one battery holds at least a 2 kWh charge.

16. A self-contained, portable electric vehicle charging device according to claim 3, wherein said handle is retractable into said housing.

17. A self-contained, portable electric vehicle charging device, comprising:
a housing;
at least one battery adapted to supply electric power to an electric vehicle disposed in said housing;
a charging cord electrically connected to said at least one battery;
a first connection terminal electrically connected to said at least one battery and configured to supply power from an external power source to said at least one battery; and
a plurality of interchangeable plugs attachable to a distal end of said charging cord and electrically connected to said at least one battery, said plurality of interchangeable plugs attachable to a plurality of different electric vehicle charging ports and thereby electrically connectable to the electric vehicle to supply power stored in said at least one battery to the electric vehicle via said charging cord.

18. A self-contained, portable method of charging an electric vehicle comprising the steps of:
providing a self-contained, portable electric vehicle charging device having:
a housing;
at least one battery adapted to supply electric power to an electric vehicle disposed in the housing;
a charging cord electrically connected to the at least one battery;
a first connection terminal electrically connected to the at least one battery and configured to supply power from an external power source to the at least one battery; and
a second connection terminal electrically connected to the at least one battery and electrically connectable to the electric vehicle to supply power stored in the at least one battery to the electric vehicle via the charging cord;
charging the battery;
connecting the self-contained, portable electric vehicle charging device to the electric vehicle; and
charging the electric vehicle.

19. A self-contained, portable method of charging an electric vehicle according to claim 18, wherein the charging cord is retractable, further comprising the step of retracting the charging cord when said electric vehicle charging step is finished.
